(19) United States
(12) Patent Application Publication
(10) Pub. No.: US 2024/0100861 A1
(43) Pub. Date: Mar. 28, 2024

(54) PRINTER DEVICES HAVING MOVABLE DISPLAY SCREENS

(71) Applicant: Hewlett-Packard Development Company, L.P., Spring, TX (US)

(72) Inventors: Michael V. LEMAN, Boise, ID (US); Alan Reid WILLIAMSON, Boise, ID (US); Dean Jonathan RICHTSMEIER, Singapore (SG)

(21) Appl. No.: 18/274,291

(22) PCT Filed: Jan. 28, 2021
(86) PCT No.: PCT/US2021/015355

§ 371 Date: Jul. 26, 2023

(51) Int. Cl. B41J 3/46; G03G 15/00

(52) U.S. Cl. CPC B41J 3/46; G03G 15/5016

(57) ABSTRACT

An example printer device includes a chassis. The example printer device further includes a paper path component along which paper is output from the chassis. The example printer device further includes a display screen movable between a stored position and a deployed position, the paper path component moving as the display screen moves.

### BACKGROUND

Large displays are becoming more prevalent on smaller printer devices.

### BRIEF DESCRIPTION OF THE DRAWINGS

Reference will now be made, by way of example only, to the accompanying drawings in which:

FIG. 1 is a block diagram of a side view of an example printer device having a movable display screen.

FIG. 2A is a perspective view an example printer device having a movable display screen, with the display screen in a stored position and a paper support in a folded position.

FIG. 2B is a perspective of details of the printer device of FIG. 2A, with the display screen in the stored position and the paper support in the folded position.

FIG. 3A is a perspective view the example printer device of FIG. 2A, with the display screen in a deployed position and the paper support in an extended position.

FIG. 3B is a perspective of details of the printer device of FIG. 3A, with the display screen in the deployed position and the paper support in the extended position.

FIG. 4A is a perspective view the example printer device of FIG. 3A, with the display screen in a deployed position, the paper support in an extended position and further showing an openable extension in an open position.

FIG. 4B is a perspective of details of the printer device of FIG. 4A, with the display screen in the deployed position, the paper support in the extended position, and the openable extension in the open position.

FIG. 5A is a perspective view of another example printer device having a movable display screen, with the display screen in a stored position and a paper support in a folded position, the paper support being slidable.

FIG. 5B is a perspective of details of the printer device of FIG. 5A, with the display screen in the stored position and the paper support in the folded position.

FIG. 6A is a perspective view the example printer device of FIG. 5A, with the display screen in a deployed position and the paper support in an extended position.

FIG. 6B is a perspective of details of the printer device of FIG. 6A, with the display screen in the deployed position and the paper support in the extended position.

FIG. 7A is a perspective view of another example printer device having a movable display screen, with the display screen in a stored position and a paper support in a folded position, the display screen and the paper support being slidably attached.

FIG. 7B is a perspective of details of the printer device of FIG. 7A, with the display screen in the stored position and the paper support in the folded position.

FIG. 8A is a perspective view the example printer device of FIG. 7A, with the display screen in a deployed position and the paper support in an extended position.

FIG. 8B is a perspective of details of the printer device of FIG. 8A, with the display screen in the deployed position and the paper support in the extended position.

FIG. 9A is a perspective view the example printer device of FIG. 7A, with the display screen in a deployed position, the paper support in an extended position and further showing an openable extension in an open position.

FIG. 9B is a perspective of details of the printer device of FIG. 9A, with the display screen in the deployed position, the paper support in the extended position, and the openable extension in the open position.

### DETAILED DESCRIPTION

Provided herein is a printer device having a movable display screen which, when moved and/or rotated between a stored position and a deployed position, a paper path component also moves, for example to prevent paper output from the printer device from blocking the display screen. In particular, the display may be rotated, for example upward, without blocking a paper path of the printer device due to the movement of the paper path component; for example, if paper output from the printer device were to hit a back of the display screen, poor stacking of the paper may occur, among other possibilities, such as paper falling from the printer device, paper jams, and the like. The display screen may provide a control panel for the printer device, which may be incorporated into a rim of a chassis of the printer device, and the display screen may be along a paper path of the printer device. Hence, when the display screen is moved, for example rotated, into a deployed position, the paper path is modified via movement of the paper path component such that paper output from the printer device is received at the paper path component rather than blocking the display screen and the paper may, for example, stack at the paper path component. Such a printer device may allow larger display screens to be incorporated into a smaller printer device along a paper path without paper blocking the display screen, generally increasing versatility of where a display screen may be incorporated into a printer device, and further the movement of the display screen and movement of the paper path component may prevent problems related to the paper hitting a back of the display screen

An aspect of the present specification provides a printer device comprising: a chassis; a paper path component along which paper is output from the chassis; and a display screen movable between a stored position and a deployed position, the paper path component moving as the display screen moves.

Another aspect of the present specification provides a printer device comprising: a chassis; an output bin at least partially defining a paper path; a display screen, along the paper path, rotatably attached to a rim of the chassis and rotatable between a stored position, at the rim, and a deployed position extending from the rim; and a paper support located along the paper path between the display screen and the output bin, the display screen rotatably attached to the paper support the paper support movable between a folded position, at the rim, and an extended position to prevent paper from blocking the display screen or to prevent the paper from hitting a back of the display screen or to prevent the display screen from blocking the paper path, the paper support movable between the folded position and the extended position as the display screen rotates respectively between the stored position and the deployed position.

Another aspect of the present specification provides a printer device comprising: a chassis; an output bin at least partially defining a paper path; a display screen rotatably attached to a rim of the chassis and movable between a stored position, at the rim, and a deployed position, extending from the rim; and a paper support located along the paper path, the display screen slidably attached to the paper support such that the paper support is pulled by the display screen from a folded position; at the rim, to an extended position, as the display screen rotates respectively from the stored position to the deployed position.

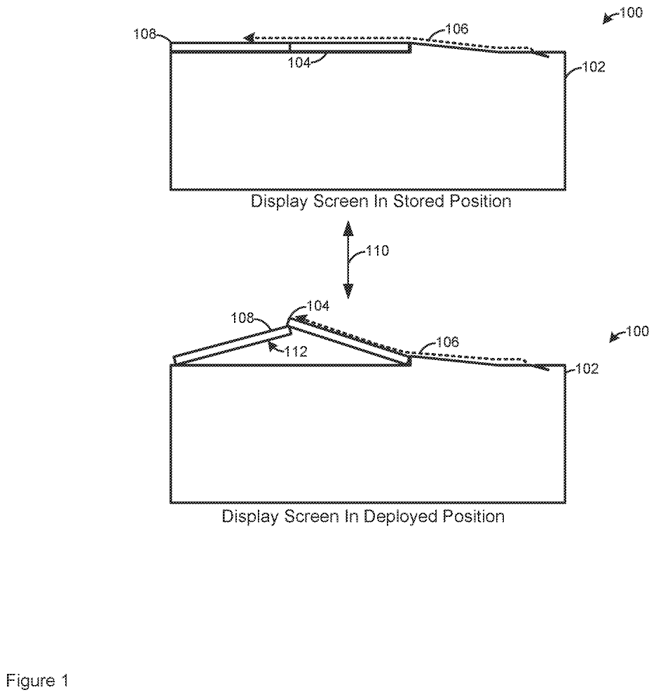

Attention is first directed to FIG. 1, which is a block diagram of an example printer device 100. The printer device 100 comprises any suitable printer device including, but not limited to, an inkjet printer, a laser printer, a home printer, a commercial printer, and the like.

The printer device 100 generally comprises a chassis 102, which may comprise (not depicted) a paper bin for storing paper, printing components, wired and/or wireless electronic connections for receiving print jobs, an output bin, and the like.

The printer device 100 further comprises a paper path component 104 along which paper is output from the chassis 102. For example, as depicted, paper may be output from the chassis 102 (e.g. from an output slot of the chassis) along a paper path 106, and the paper path component 104 may comprise a paper support which may receive paper output from the chassis 102 along the paper path 106. It is understood that a paper path as described herein may be a portion of a of paper path through a printer devices described herein, which may, for example, start at a paper bin and end outside and/or at an outer side of such printer devices.

The printer device 100 further comprises a display screen 108 movable and/or rotatable between a stored position (e.g. as depicted in an upper portion of FIG. 1) and a deployed position (e.g. as depicted in a lower portion of FIG. 1). In particular, the display screen 108 may rotate between the stored position and the deployed position. In FIG. 1, a change in the display screen 108 between the stored position and the deployed position at the printer device 100 is indicated by an arrow 110 between the upper and lower portions of FIG. 1. The display screen 108 may be moved and/or rotated by a user gripping the display screen 108, and/or an edge of the display screen 108, and rotating the display screen 108 between the stored position and the deployed position.

As is also depicted in FIG. 1, the paper path component 104 moves as the display screen 108 moves. For example, when the display screen 108 is in the stored position, the paper path component 104 is in a folded position (e.g. as depicted in the upper portion of FIG. 1) which, as depicted, is flush with the display screen 108 in the stored position.

In contrast, the paper path component 104 moves and/or rotates into an extended position (e.g. as depicted in the lower portion of FIG. 1) when the display screen 108 moves and/or rotates into the deployed position. For example, as seen in the lower portion of FIG. 1, the paper path component 104 may move and/or rotate to receive paper along the paper path 106 to prevent the paper from blocking the display screen 108 when the display screen 108 is in the deployed position, or to prevent the paper from hitting a back 112 of the display screen 108 (e.g. side of the display screen 108 which, in the deployed position, may face the paper path 106, and/or prevents the display screen 108 from blocking the paper path 106. For example, the paper path component 104 may form a ramp which receives paper along the paper path 106, when the display screen 108 is in the deployed position, and (as depicted), the paper path component 104 may extend over the display screen 108 in the deployed position to further assist with preventing paper from blocking the display screen 108 and/or assist with preventing the paper from hitting the back 112 of the display screen 108 and/or assist with preventing the display screen 108 from blocking the paper path 106.

In some examples, the display screen 108 may be further movable to positions between the stored position and the deployed position, and the paper path component 104 may similarly be further movable to corresponding positions. Put another way, in these examples, the display screen 108 may be stopped at any position between the stored position and the deployed position, with the paper path component 104 stopped accordingly at any corresponding position between a folded position and an extended position. Furthermore, it is understood that the display screen 108 may be usable (e.g. as a control panel for the printer device 100) in the stored position and the deployed position, as well at any position between the stored position and the deployed position; put another way, in the stored position (and/or any other position), the display screen 108 may also be used to control the printer device 100, and/or provide information associated with the printer device 100, such as status of the printer device 100 (e.g. number of pages printed, ink levels, etc.), and the like.

The display screen 108 be located at a rim and/or top side of the chassis 102 and, in the stored position, the display screen 108 may be at 0° to the chassis 102. However, in the deployed position, the display screen 108 may be at a non-zero angle to the chassis 102, such as 25°, 30°, 40°, and/or any other suitable angle. The paper path component 104 may be rotatably and/or slidable attached to the display screen 108 such that, as the display screen 108 moves, the display screen 108 applies a mechanical force to the paper path component 104 causing the paper path component 104 to also move. Hence, for example, the paper path component 104 may also be located at a rim and/or top side of the chassis 102, and, in a folded position, the paper path component 104 may be at 0° to the chassis 102. However, in an extended position, the paper path component 104 may be at a non-zero angle to the chassis 102, such as 25°, 30°, 40°, and/or any other suitable angle. Such angles of the display screen 108 and the paper path component 104 are understood to be examples, and any combination of angles, and/or shapes of the display screen 108 and the paper path component 104, are within the scope of the present specification; for example, the paper path component 104 may be at least partially curved such that different portions of the paper path component 104 form different angles to the chassis 102.

It is hence further understood that, as the display screen 108 moves, the paper path 106 is modified. For example, comparing the upper and lower portions of FIG. 1, with the display screen 108 in the stored position, the paper path 106 may extend over the paper path component 104 and over the display screen 108 while, with the display screen 108 in the deployed position, the paper path 106 may be along the paper path component 104 but not over the display screen 108 and/or not along the display screen 108.

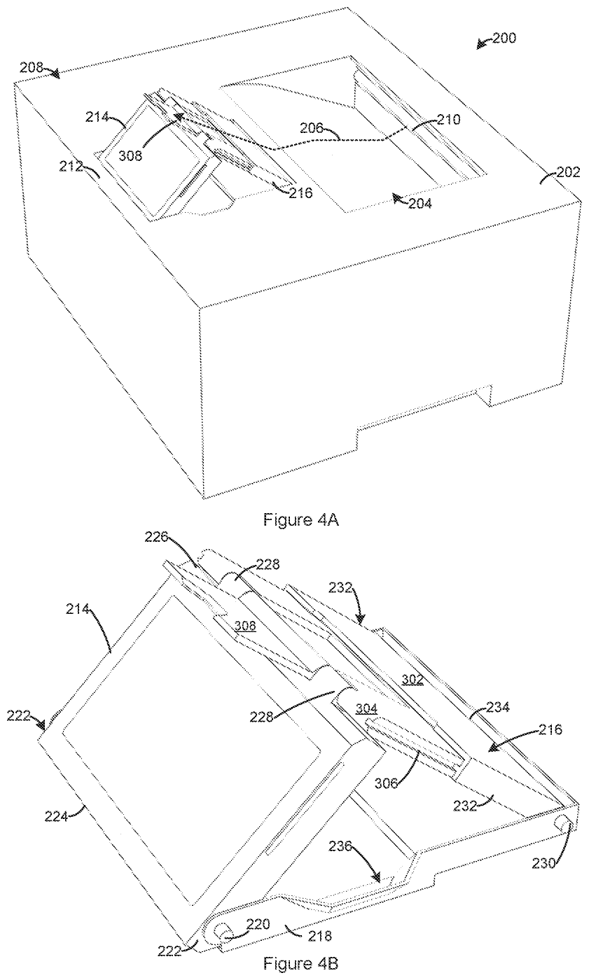

While not depicted, the paper path component 104 may alternatively include an openable extension which extends over the display screen 108 in the deployed position when the openable extension is opened, similar as described below with respect to FIG. 4A and FIG. 4B.

The paper path component 104 and/or the display screen 108 may comprise any suitable mechanical components for enabling the display screen 108 to be movable between the stored position and the deployed position, and enabling the paper path component 104 to move as the display screen 108 moves. For example, the display screen 108 may be mechanically hinged to the chassis 102, and the paper path component 104 may be hinged to the display screen 108, and slidably attached to the chassis 102. Various examples of such mechanical components of printer devices, display screens and paper path components are described below.

Furthermore, the display screen 108 may be located in any suitable position relative to the paper path 106. For example, as depicted, the display screen 108 may be located along the paper path 106, or the display screen 108 may be located to a side of the paper path 106, but still partially along the paper path 106. In particular, the paper path component 104 moving as the display screen 108 moves may allow the display screen 108 to be incorporated at the chassis 102 at a location along, and/or at least partially along, the paper path 106; so that, when the display screen 108 is in the deployed position, the paper path component 104 moves to receive paper to prevent the paper from blocking the display screen 108 or to prevent the paper from hitting the back 112 of the display screen 108 or to prevent the display screen 108 from blocking the paper path 106.

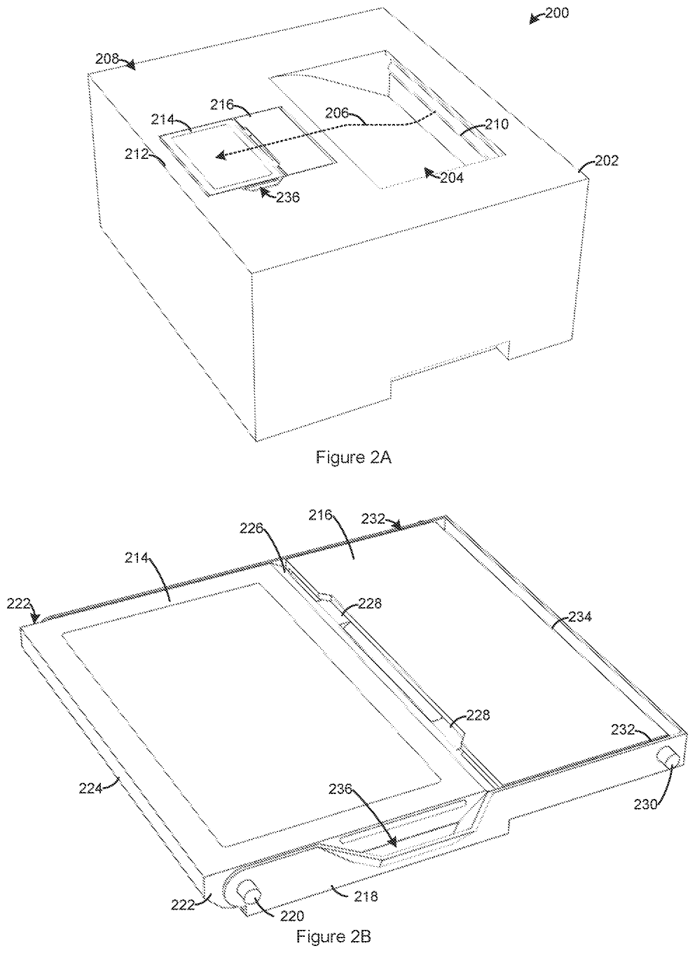

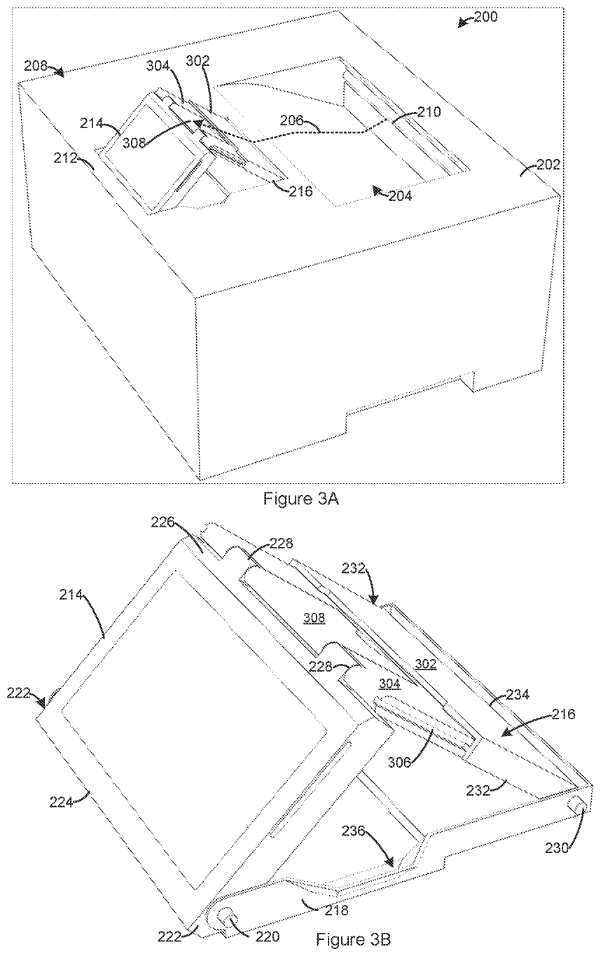

Attention is next directed to FIG. 2A, FIG. 3A, and FIG. 4A, which depict perspective views of different configurations of a printer device 200 with a movable display screen, and a paper support that moves with the display screen. The printer device 200 is described with further reference to FIG. 2B, FIG. 3B, and FIG. 4B which show respective detail of the display screen and the paper support in the configurations of FIG. 2A, FIG. 3A, and FIG. 4A.

With attention first directed to FIG. 2A and FIG. 2B, the printer device 200 comprises a chassis 202 and an output bin 204 at least partially defining a paper path 206. For example, as depicted, the output bin 204 comprises a depression at a top side 208 of the chassis 202. The output bin 204 includes a slot 210 from which paper (not depicted) exits along the paper path 206 when a print job, and the like, is executed at the printer device 200. The output bin 204 is generally to receive the paper, but the paper may further travel along the paper path 206 towards a rim 212 of the chassis 202. Hence, while the paper path 206 is depicted as a line, the paper path 206 may be as wide as paper output from the slot 210 and may be, for example as wide as the output bin 204, which may also be at least as wide as paper output from the slot 210.

As depicted, the rim 212 of the chassis 202 is understood to include a portion of a side of the chassis 202 (including, but not limited to, the top side 208 of the chassis 202), between the output bin 204 and an edge of the chassis 202. However, the rim 212 may be include a portion of any suitable side of the chassis 202.

As depicted, the printer device 200 further comprises a display screen 214, along the paper path 206. The display screen 214 may comprise a control panel of the printer device 200, such as a touch screen display screen, and the like, which may be used to control printing at the printer device 200 and/or provide information associated with the printer device 200, such as status of the printer device 200, and the like.

The printer device 200 further comprises a paper support 216 located along the paper path 206 between the display screen 214 and the output bin 204.

In FIG. 2A and FIG. 2B, the display screen 214 is understood to be in a stored position where the display screen 214 may be recessed at the rim 212, and the paper support 216 is understood to be in a folded position where the paper support 216 may be also recessed at the rim 212. As depicted, in the stored position, the display screen 214 may be flush with the top side 208 of the chassis 202 and, similarly, in the folded position, the paper support 216 may be flush with the top side 208 of the chassis 202. However, in other examples, in the stored position and folded position, the display screen 214 and the paper support 216, respectively, may not be recessed in the rim 212 and/or may not be flush with the top side of the chassis 202.

Regardless, as best seen in FIG. 2A, the paper path 206 may extend over both the display screen 214 and the paper support 216 such that, when paper exits from the slot 210 into the output bin 204, the paper may at least partially travel along the paper path 206 over the paper support 216, and onto the display screen 214, which may partially and/or fully block the display screen 214.

Hence, the display screen 214 is rotatably attached to the rim 212 and/or the top side 208 of the chassis 202. In particular, the display screen 214 is rotatable between the stored position, at the rim 212 and/or the top side 208 of the chassis 202, and a deployed position extending from the rim 212 and/or the top side 208 of the chassis 202, as best seen in FIG. 3A and FIG. 3B.

The display screen 214 may be rotatably attached to the paper support 216, and the paper support 216 may hence be similarly movable between the folded position (e.g. at the rim 212 and/or the top side 208 of the chassis 202), and an extended position, extending from the rim 212 and/or the top side 208 of the chassis 202, as also best seen in FIG. 3A and FIG. 3B. In the extended position, the paper support 216 prevents paper from blocking the display screen 214. In particular, the paper support 216 is movable between the folded position and the extended position as the display screen 214 rotates respectively between the stored position and the deployed position.

Hence FIG. 2A and FIG. 2B are understood to show the display screen 214 in the stored position and the paper support 216 in the folded position, and FIG. 3A and FIG. 3B are understood to show the display screen 214 in the deployed position and the paper support 216 in the extended position. FIG. 3A and FIG. 3B are described in more detail below.

Attention is directed to FIG. 2B, which shows details of mechanical components of the printer device 200 that allows the display screen 214 to rotate between the stored position and the deployed position, and further allows the paper support 216 to move between the folded position and the extended position as the display screen 214 moves.

As depicted, the display screen 214 and the paper support 216 may be provided in a tray 218 that may be incorporated into the rim 212 and/or the top side 208 of the chassis 202. However, the tray 218 may be optional. As depicted, the display screen 214 is rotatably attached to the rim 212 (and/or the top side 208 of the chassis 202 and/or the tray 218) via hinges 220 extending from opposite edges 222 of the display screen 214 that are about parallel to the paper path 206; while only one hinge 220 is visible in FIG. 2B due to the depicted perspective, it is understood that a second hinge 220 is located at an opposite edge 222. As depicted, the hinges 220 are understood to be perpendicular to the paper path 206 however, in other examples, a hinge, and/or hinges, may be provided at an edge 224 of the display screen 214 that is perpendicular to the paper path 206 and/or perpendicular to the edges 222, and opposite an edge 226 of the display screen 214 that is rotatably attached to the paper support 216.

In particular, as depicted, the display screen 214 and the paper support 216 are connected via a hinge 228 and/or hinges 228, and the paper support 216 is rotatably attached to the rim 212 (and/or the top side 208 of the chassis 202 and/or the tray 218) via hinges 230, only one of which is visible in FIG. 2B, similar to the hinges 220. Also similar to the hinges 220, the hinges 230 extend from opposite edges 232 of the paper support 216 that are about parallel to the paper path 206. As depicted, the hinges 230 are understood to be perpendicular to the paper path 206 however, in other examples, a hinge, and/or hinges, may be provided at an edge 234 of the paper support 216 that is perpendicular to the paper path 206 and/or perpendicular to the edges 232, and opposite an edge 226 of the display screen 214 that is rotatably attached to the paper support 216 via the hinge 228. While the printer device 200 is described with respect to the paper support 216 being attached to the rim 212 (and/or the top side 208 of the chassis 202 and/or the tray 218), it is understood that the paper support 216 may be attached to any suitable portion of the printer device 200.

As depicted, the printer device 200 further comprises a recess 236 in the rim 212 (and/or the top side 208 of the chassis 202 and/or the tray 218), for example beside the display screen 214, to provide manual access to an edge 222 of the display screen 214 to pull the display screen 214 from the stored position towards the deployed position. Alternatively, and/or in addition, the printer device 200 may further comprise a suitable motor which may be actuated via a button, and/the like, which moves the display screen 214 between the stored position and the deployed position. However, the display screen 214 may be moved from the stored position towards the deployed position in any suitable manner.

Attention is next directed to FIG. 3A and FIG. 3B which depicts the display screen 214 in the deployed position and the paper support 216 in the extended position.

In particular, in the depicted example, the paper support 216 comprises a first portion 302 and a second portion 304, the first portion 302 rotatably attached to the rim 212 (and/or the top side 208 of the chassis 202 and/or the tray 218), for example via the hinges 230), and the second portion 304 extendable from the first portion 302. For example, as depicted, the second portion 304 may be recessable into the first portion 302 via a tongue and groove mechanism 306. As has already been explained the display screen 214 may be rotatably attached to the rim 212 and/or the top side 208 of the chassis 202 and/or the tray 218 via the hinges 220. Furthermore, the display screen 214 may be rotatably attached the second portion 304 via the hinges 228. Hence, as the display screen 214 rotates from the rim 212 (and/or the top side 208 of the chassis 202 and/or the tray 218) towards the deployed position, the display screen 214 pulls on the second portion 304 and extends the second portion 304 from the first portion 302, as the first portion 302 rotates relative to the rim 212 (and/or the top side 208 of the chassis 202 and/or the tray 218), also causing the second portion 304 to rotate, causing the paper support 216, as a whole, to move into the extended position.

Similarly, as the display screen 214 rotates back towards the stored position, the display screen 214 pushed the second portion 304 back into the first portion 302, and the first portion 302 rotates relative to the rim 212 (and/or the top side 208 of the chassis 202 and/or the tray 218) also causing the second portion 304 to rotate, causing the paper support 216, as a whole, to move into the folded position.

Comparing FIG. 2A and FIG. 3A it is further apparent that moving the display screen 214 also modifies the paper path 206. In particular, in FIG. 3A, the paper support 216 in the extended position is understood to form a ramp on a side opposite the display screen 214 and/or between the display screen 214 and the output bin 204 such that paper exiting the slot 210 moves along the paper path 206, to the output bin 204, and up the ramp formed by the paper support 216 in the extended position; hence, the paper exiting the slot 210 may stack at the paper support 216. As such, paper exiting the chassis 202 is prevented from blocking the display screen 214, and/or paper exiting the slot 210 is prevented from hitting a back of the display screen 214, and/or the display screen 214 is prevented from blocking the paper path 206, which may assist with preventing paper jams and/or poor stacking of the paper (e.g. if the paper support 216 were not present), as described above.

To further assist with preventing paper from blocking the display screen 214, the paper support 216 may optionally include an openable extension 308 which extends over the display screen 214 in the deployed position, when the openable extension 308 is opened. For example, in FIG. 3A and FIG. 3B, the openable extension 308 is in a closed position, and in FIG. 4A and FIG. 4B, the openable extension 308 in an open position. FIG. 4A is otherwise similar to FIG. 3A, and FIG. 4B is otherwise similar to FIG. 3B.

In particular, as depicted, in the closed position depicted in FIG. 3B, the openable extension 308 may be recessed into the second portion 304, and the openable extension 308 may be opened by manually rotating the openable extension 308 (e.g. via the hinges 228, which may also be used to rotatably attach the openable extension 308 the second portion 304, and/or other hinges; as such, the hinges 228 are understood to be located along the edge 226 to accommodate rotation of the openable extension 308). Alternatively, the openable extension 308 may be recessable into the second portion 304 using a tongue and groove mechanism and the like, similar to tongue and groove mechanism 306.

In particular, as best seen in FIG. 4A, when the openable extension 308 is opened, the paper path 206 may be further extended along the openable extension 308 as the openable extension 308 may extend the ramp formed by the paper support 216.

It is further understood that, to move the display screen 214 back into the stored position, and to move the paper support 216 back into the folded position, the openable extension 308 may be first closed, for example manually and/or using a suitable motor.

Hence, it is understood that FIG. 2A, FIG. 3A, and FIG. 4A, and similarly FIG. 2B, FIG. 3B, and FIG. 4B, show a sequence in time for opening (or, in reverse, closing), the display screen 214, the paper support 216 and the openable extension 308.

While in the example of FIG. 2A, FIG. 3A, and FIG. 4A, the paper support 216 is rotatably attached to the rim 212 (and/or the top side 208 of the chassis 202 and/or the tray 218), in other examples a printer device may be provided having a paper support which is slidably attached to a rim (and/or a top side of a chassis and/or a tray), to move as a display screen moves.

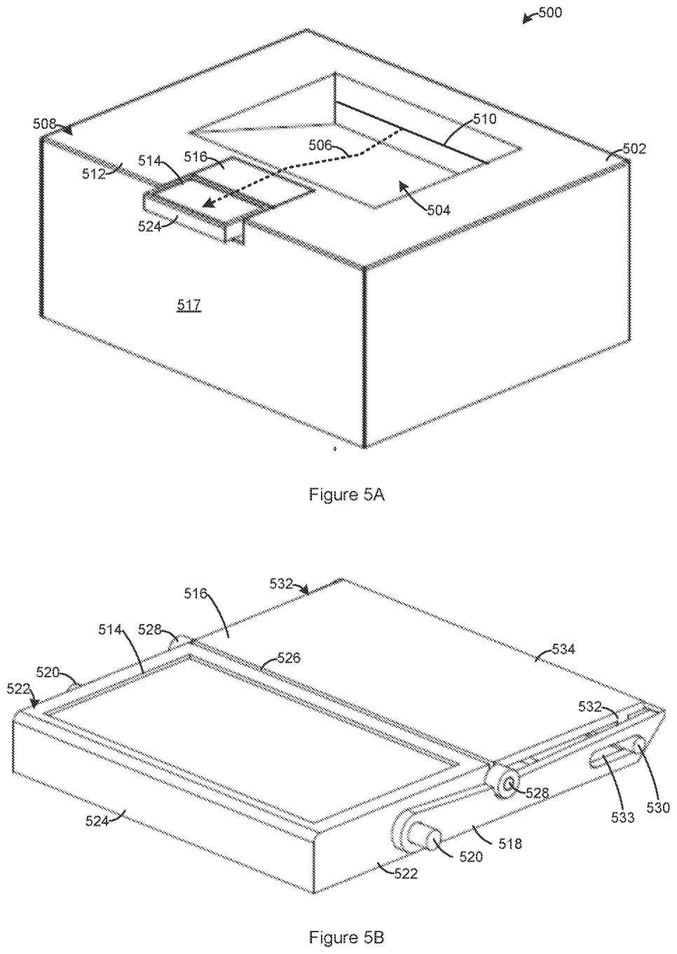

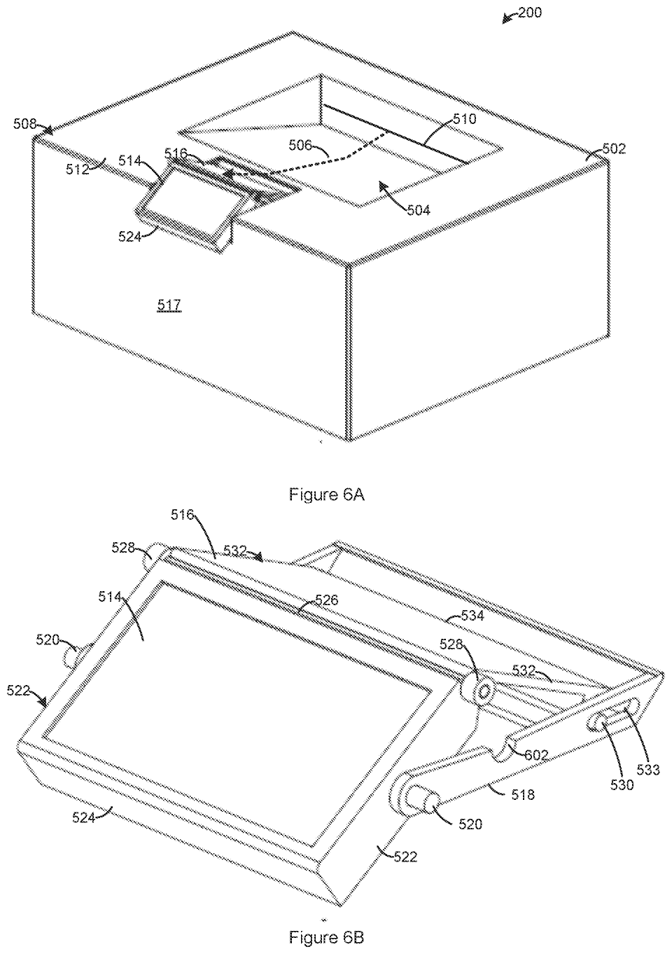

Attention is next directed to FIG. 5A and FIG. 6A, which depict perspective views of different configurations of a printer device 500 with a movable display screen, and a paper support that moves with the display screen. The printer device 500 is described with further reference to FIG. 5B and FIG. 6B which show respective detail of the display screen and the paper support in the configurations of FIG. 5A and FIG. 6A.

Furthermore, the printer device 500 is substantially similar to the printer device 200, with like components having like numbers, but in a “500” series rather than a “200” series, unless otherwise indicated.

With attention first directed to FIG. 5A and FIG. 5B, the printer device 500 comprises a chassis 502 and an output bin 504 at least partially defining a paper path 506. For example, as depicted, the output bin 504 comprises a depression at a top side 508 of the chassis 502. The output bin 504 includes a slot 510 from which paper (not depicted) exits along the paper path 506 when a print job, and the like, is executed at the printer device 500. The output bin 504 is generally to receive the paper, but the paper may further travel along the paper path 506 towards a rim 512 of the chassis 502. As depicted, the rim 512 of the chassis 502 is understood to include an edge of the chassis 502 similar to the rim 212.

As depicted, the printer device 500 further comprises a display screen 514, along the paper path 506, similar to the display screen 214. The printer device 500 further comprises a paper support 516 located along the paper path 506 between the display screen 514 and the output bin 504.

In FIG. 5A and FIG. 5B, the display screen 514 is understood to be in a stored position where the display screen 514 may be recessed at the rim 512, and the paper support 516 is understood to be in a folded position where the paper support 516 may be also recessed at the rim 512.

In contrast to the display screen 214, however, the display screen 514 of the printer device 500 is configured to hang outwards from the rim 512 and/or the top side 508 of the chassis 502 (e.g. as depicted, an edge 524 the display screen 514, opposite the paper support 516, hangs outward). A side 517 of the printer device 500 may be perpendicular and/or about perpendicular (and/or at any other suitable angle) to the top side 508, and over which the display screen 514 hangs, may be adapted to include a ridge (not depicted) on either side of the display screen 514 to better protect the display screen 514 from being bumped, and the like. However, it is understood that, in other examples, the display screen 514 may not hang outwards from the rim 512; rather, the edge 524 may be flush with the side 517 of the printer device 500, and/or the edge 524 may be set back from the side 517 (e.g. similar to the display screen 214).

As best seen in FIG. 5A, the paper path 506 may extend over both the display screen 514 and the paper support 516 such that, when paper exits from the slot 510 into the output bin 504, the paper may at least partially travel along the paper path 506 over the paper support 516, and onto the display screen 514, which may block the display screen 514.

Hence, similar to the display screen 214, the display screen 514 is rotatably attached to the rim 512 and/or the top side 508 of the chassis 502, and is rotatable between the stored position and a deployed position, as best seen in FIG. 6A and FIG. 6B.

The display screen 514 is rotatably attached to the paper support 516, and the paper support 516 is similarly movable between the folded position, as also best seen in FIG. 6A and FIG. 6B. In the extended position, the paper support 516 prevents paper from blocking the display screen 514 and/or prevents the paper from hitting a back of the display screen 514 and/or prevents the display screen 514 from blocking the paper path 506. In particular, the paper support 516 is movable between the folded position and the extended position as the display screen 514 rotates respectively between the stored position and the deployed position.

Hence FIG. 5A and FIG. 5B are understood to show the display screen 514 in the stored position and the paper support 516 in the folded position, and FIG. 6A and FIG. 6B are understood to show the display screen 514 in the deployed position and the paper support 516 in the extended position. FIG. 6A and FIG. 6B are described in more detail below.

Attention is directed to FIG. 5B, which shows details of mechanical components of the printer device 500 that allows the display screen 514 to rotate between the stored position and the deployed position, and further allows the paper support 516 to move between the folded position and the extended position as the display screen 514 moves.

As depicted, the display screen 514 and the paper support 516 may be provided in a tray 518 that may be incorporated into the rim 512 and/or the top side 508 of the chassis 502. However, in comparison to the tray 218, the tray 518 is configured such that the display screen 514 (e.g. the edge 524) extends out of the tray 518, for example along the paper path 506, to provide the overhang depicted in FIG. 5A.

However, the tray 518 may be optional. As depicted, the display screen 514 is rotatably attached to the rim 512 (and/or the top side 508 of the chassis 502 and/or the tray 518) via hinges 520 extending from opposite edges 522 of the display screen 514 that are about parallel to the paper path 506. As depicted, the hinges 520 are understood to be perpendicular to the paper path 506. In contrast to the display screen 214, as the edge 524 of the display screen 514 hangs over the side 517, a hinge may not be provided at the edge 524. For clarity, similar to the edge 224, the edge 524 is understood to be perpendicular to the paper path 506 and/or perpendicular to the edges 522 (e.g. and opposite an edge 526 of the display screen 514 that is rotatably attached to the paper support 516).

In particular, as depicted, the display screen 514 and the paper support 516 are connected via a hinge 528 and/or hinges 528 at the edge 526. However, in contrast to the paper support 216, the paper support 516 is slidably attached to the rim 512 (and/or the top side 508 of the chassis 502 and/or the tray 518) via a sliding mechanisms which, as depicted, are provided as posts 530 complementary slots and/or grooves 533 of the rim 512 (and/or the top side 508 of the chassis 502 and/or the tray 518). The posts 530 are provided on opposite edges 532 of the paper support 516 and slide in the complementary slots and/or grooves 533; as such, the grooves 533 define paths of the posts 530. While only one set of a post 530 and a complementary groove 533 is visible in FIG. 5B, due to the depicted perspective, it is understood that a second set of a post 530 and a complementary groove 533 is located at an opposite edge 532. The groove 533 is depicted as being about parallel to the edges 522, 532, to better facilitate movement of the paper support 516 as described hereafter, but the grooves 533 may be at any suitable angle and/or of any suitable configuration.

The posts 530 extend from opposite edges 532 of the paper support 516 that are about parallel to the paper path 506 and opposite the edge 526. As depicted, the posts 530 are understood to be perpendicular to the paper path 506 however, in other examples, the posts 530 may be at any suitable angle and/or position.

Regardless, the display screen 514 may be moved manually into the deployed position, for example by pressing “down” on the display screen 514, and/or by applying a force to the display screen 514 about perpendicular to the top side 508 close to the overhanging edge 524. Alternatively, and/or in addition, the printer device 500 may further comprise a suitable motor which may be actuated via a button, and/the like, which moves the display screen 514 between the stored position and the deployed position.

Attention is next directed to FIG. 6A and FIG. 6B which depicts the display screen 514 in the deployed position and the paper support 516 in the extended position.

In particular, in the depicted example, the paper support 516 is understood to be slidably attached to the rim 512 and/or the top side 508 of the chassis 502 and/or the tray 518, via the posts 530 and grooves 533, such that, as the display screen 514 rotates from the rim 512 and/or the top side 508 of the chassis 502 and/or the tray 518, towards the deployed position, the paper support 516 is slidably pulled relative to the rim 512 and/or the top side 508 of the chassis 502 and/or the tray 518 into the extended position.

For example, pushing down, and the like, on the display screen 514 causes the display screen 514 to rotate via the hinges 520, which causes the display screen 514 to apply a force via the hinges 528 to the paper support 516 which both rotates relative to the display screen 514 via the hinges 528 at the edge 526, and is pulled towards the display screen 514 via the posts 530 sliding in the grooves 533. The edge 534 of the paper support 516 moves towards and/or into the rim 512 (and/or the top side 508 of the chassis 502 and/or the tray 518) as the paper support 516 rotates into the extended position.

Put another way, the paper support 516 may be slidably attached to the rim 512 (and/or the top side 508 of the chassis 502 and/or the tray 518), such that, as the display screen 514 rotates from the rim 512 (and/or the top side 508 of the chassis 502 and/or the tray 518) towards the deployed position, the paper support 516 is slidably pulled relative to the rim 512 (and/or the top side 508 of the chassis 502 and/or the tray 518) into the extended position.

Comparing FIG. 5A and FIG. 6A it is further apparent that moving the display screen 514 also modifies the paper path 506. In particular, in FIG. 5A, the paper support 516 in the extended position is understood to form a ramp on a side opposite the display screen 514 and/or between the display screen 514 and the output bin 504 such that paper exiting the slot 510 moves along the paper path 506, to the output bin 504, and up the ramp formed by the paper support 516 in the extended position. As such, paper exiting the chassis 502 is prevented from blocking the display screen 514 and/or the paper exiting the chassis 502 is prevented from hitting a back of the display screen 514 and/or the display screen 514 is prevented from blocking the paper path 506.

While not depicted, the printer device 500 may include an extension similar to the extension 308.

Also depicted in FIG. 6B, the tray 518 and/or the rim 512 may include a recesses 602 for receiving the hinges 528 which extend from perpendicular from the edges 522, 532.

Hence, it is understood that FIG. 5A and FIG. 6A, and similarly FIG. 5B and FIG. 6B, show a sequence in time for opening (or, in reverse, dosing), the display screen 514 and the paper support 516.

While in the examples of FIG. 2A, FIG. 3A, FIG. 4A, FIG. 5A and FIG. 6A display screens are attached to paper supports via hinges, in other examples printer devices may be provided in which display screens are attached to paper supports via sliding mechanisms. Similarly, while in the examples of FIG. 2A, FIG. 3A, FIG. 4A, FIG. 5A and FIG. 6A display screens are directly aligned with a paper path, in other examples, printer devices may be provided in which display screens are partially out of a paper path.

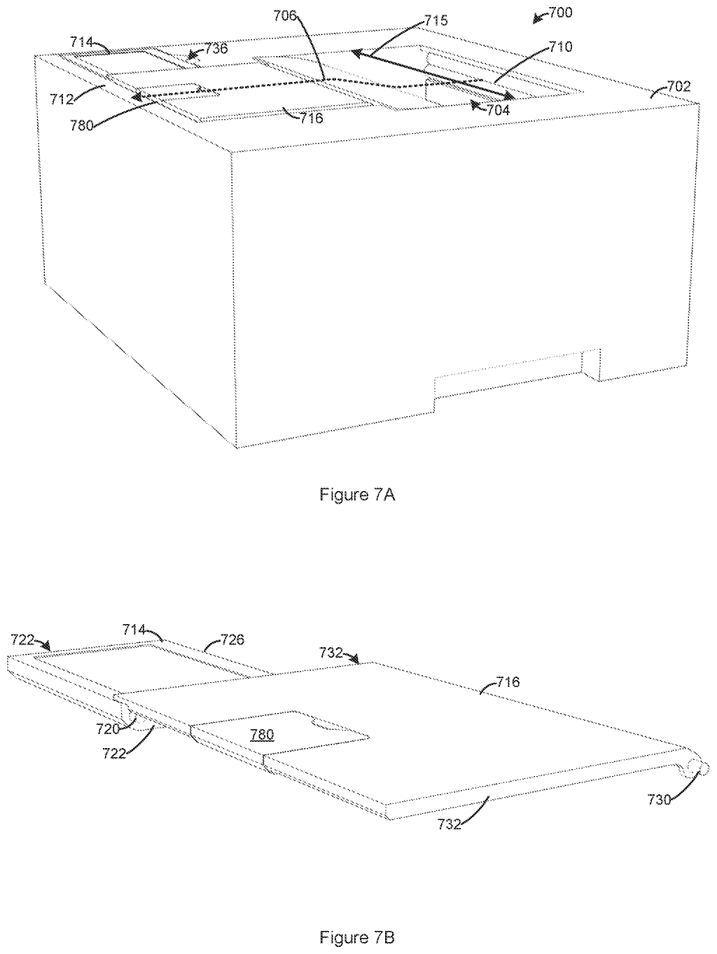

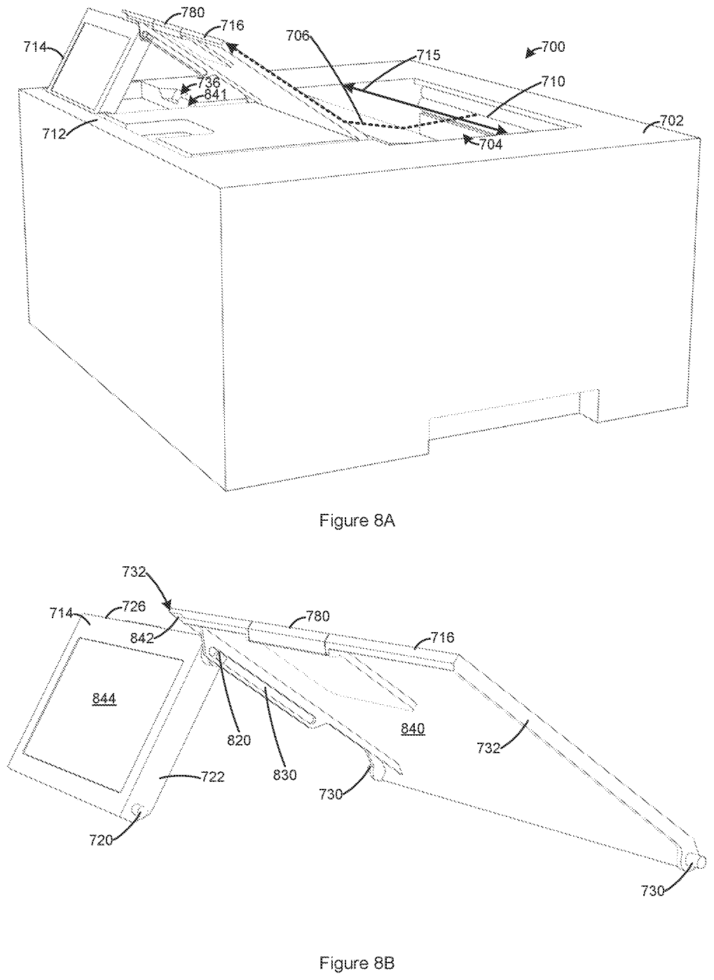

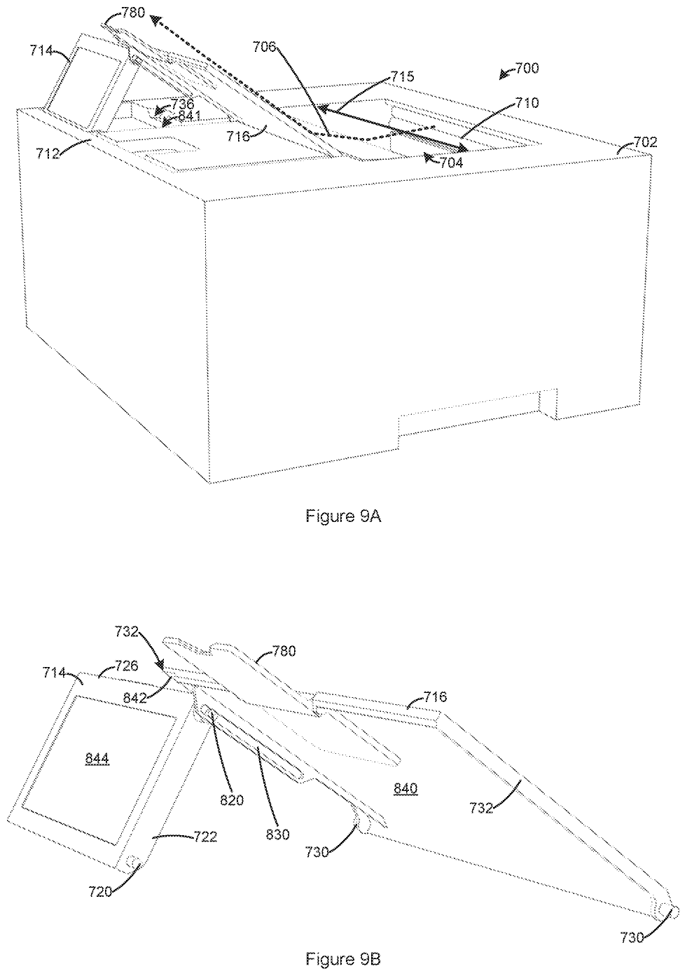

For example, attention is next directed to FIG. 7A, FIG. 8A and FIG. 9A, which depict perspective views of different configurations of a printer device 700 with a movable display screen, and a paper support that moves with the display screen. The printer device 700 is described with further reference to FIG. 78, FIG. 8B and FIG. 9B which show respective detail of the display screen and the paper support in the configurations of FIG. 7A, FIG. 8A and FIG. 9A.

Furthermore, the printer device 700 is substantially similar to the printer device 200, with like components having like numbers, but in a “700” series rather than a “200” series.

The printer device 700 comprises a chassis 702 and an output bin 704 at least partially defining a paper path 706 for example along which paper travels when exiting a slot 710 of the chassis 702. The chassis 702 includes a rim 712, and the printer device 700 further comprises a display screen 714 rotatably attached to the rim 712, and the like, and movable between a stored position, at the rim, as depicted in FIG. 7A and FIG. 7B, and a deployed position, extending from the rim 712, as depicted in FIG. 8A and FIG. 8B. However, in contrast to the display screens of printer devices described heretofore, the display screen 714 is offset from the paper path 706. In particular, as depicted, the output bin 702 has a width 715, perpendicular to the paper path 706, which may about correspond to width of paper output by the printer device 700 along the paper path 706; as depicted, the display screen 714 may partially overlap the width 715, such that the display screen 714 at least partially overlaps the paper path 706 (e.g. assuming the paper path 706 also has the width 715).

The printer device 700 further comprises a paper support 716 located along the paper path 706. As will be described below, the display screen 714 is slidably attached to the paper support 716 such that the paper support 716 is pulled by the display screen 714 from a folded position, at the rim 712, and the like, to an extended position, depicted in FIG. 8A and FIG. 8B, as the display screen 714 rotates respectively from the stored position to the deployed position.

With reference to FIG. 7B, the display screen 714 may be rotatably attached to the rim 712, and the like, via hinges 720 (e.g. a post portion of one hinge depicted in FIG. 7B), at opposing edges 722, and the paper support 716 may be rotatably attached to the rim 712, and the like, via hinges 730 (e.g. a post portion of one hinge depicted in FIG. 7B), at opposing edges 732. While the printer device 700 is depicted without a tray, in other examples the display screen 714 and the paper support 716 may be provided in a tray, similar to the tray 218 and/or the tray 518.

The display screen 714 is understood to have an edge 726 similar to the edge 226, and may be manually rotated via a recess 736 in the rim 712, and the like, for example beside the display screen 214 at the edge 726, to provide manual access to the edge 726 of the display screen 214 to pull the display screen 214 from the stored position towards the deployed position. Alternatively, and/or in addition, the printer device 700 may further comprise a suitable motor which may be actuated via a button, and/the like, which moves the display screen 714 between the stored position and the deployed position.

However, in further contrast to the display screens of printer devices described heretofore, the display screen 714 and the paper support 716 are located side-by-side at adjacent edges 722, 732, and slidably attached to one another via a sliding mechanism best seen in FIG. 8B. For example, the display screen 714 may comprise sliding mechanism provided in the form of a post 820, extending from the depicted edge 722 at an end opposite that of the hinge 720, and a complementary groove 830 along a back side 840 of the paper support 716, with the groove 830 being about parallel to the edges 732. The post 820 generally extends into the groove 830, and the groove 830 defines a path of the post 820. As such, as the display screen 714 is rotated from the stored position in FIG. 7B to the deployed position in FIG. 8B, the post 820 is pulled along the groove 830, and moves along the groove 830, to pull the paper support 716 into the extended position. It is understood that the rim 712, and the like, may comprise a recess 841 between the display screen 714 and the paper support 716 to accommodate the groove 830 in the stored position, as best seen in FIG. 8A.

As also seen in FIG. 8B, the back side 840 of the paper support 716 may include a recessed portion 842 along the edge 732 adjacent the display screen 714 such that, in the stored position, the recessed portion 842 resides against a front side 844 of the display screen 714, for example adjacent the depicted edge 722. As such, in these examples, the positions of the display screen 714 and the paper support 716 may be understood to at least partially overlap.

In particular, in these examples, the display screen 714 may be recessed, and/or partially recessed, at the rim 712, and the like, in the stored position, and the paper support 716 may be recessed, and/or partially recessed, at the rim 712, and the like, in the folded position. Furthermore, the paper support 716 may at least partially reside on the display screen 714 in the folded position.

Hence, in these examples, the display screen 714 is understood to be adjacent the paper support 716, out of the paper path 706, or partially out of the paper path 706, the display screen 714 slidably attached to the paper support 716 using one sliding mechanism as represented by the post 820 and groove 830.

While not depicted, in other examples, the display screen 714 may be about aligned with the paper support 716, for example, along the paper path 706 such that, in the stored position the display screen 714 may be hidden by the paper support 716 in the folded position. In these examples, the display screen 714 may be slidably attached to the paper support 716 using one sliding mechanism (e.g. a post 820 and groove 830 at one edge 722 of the display screen 714) or two sliding mechanisms (e.g. a post 820 and groove 830 combination at opposing edges 722 of the display screen 714).

Attention is briefly returned to FIG. 7A and FIG. 7B which further depicts an optional openable extension 780 in a closed position at the paper support 716. The openable extension 780 is similar to the openable extension 308 and is also depicted in open position in FIG. 9A and FIG. 9B, which are otherwise respectively similar to FIG. 8A and FIG. 8B.

Hence, comparing to FIG. 7A, FIG. 8A and FIG. 9A, the paper path 706 is modified when the display screen 714 is rotated to the deployed position to extend along a ramp formed by the paper support 716; and the paper path 706 is further modified, when the optional openable extension 780 opened, to extend along the openable extension 780, which extends the ramp formed by the paper support 716.

Hence, it is understood that FIG. 7A, FIG. 8A, and FIG. 9A, and similarly FIG. 7B, FIG. 8B, and FIG. 9B, show a sequence in time for opening (or, in reverse, closing), the display screen 714, the paper support 716 and the extension 780.

At example printer devices provided herein, a display screen (e.g. and/or a control panel) may be located (e.g. at least partially) along a paper path, and paper path is generally modified by moving the display screen to paper exiting the printer devices from blocking the display screen or to prevent the paper from hitting a back of the display screen or to prevent the display screen from blocking the paper path. As such, a location of the display screen at printer devices provided herein may be more versatile as compared to other printer devices lacking the features described herein.

It should be recognized that features and aspects of the various examples provided above may be combined into further examples that also fall within the scope of the present disclosure.

1. A printer device comprising:
a chassis;
a paper path component along which paper is output from the chassis; and
a display screen movable between a stored position and a deployed position, the paper path component moving as the display screen moves.

2. The printer device claim 1, wherein the display screen is located along a paper path or the display screen is located at least partially along the paper path.

3. The printer device claim 1, wherein the display screen is further movable to positions between the stored position and the deployed position, and the paper path component is further movable to corresponding positions.

4. The printer device claim 1, wherein the paper path component is movable to receive the paper to prevent the paper from blocking the display screen when the display screen is in the deployed position or to prevent the paper from hitting a back of the display screen.

5. The printer device claim 1, wherein the paper path component extends over the display screen in the deployed position, or the paper path component includes an openable extension which extends over the display screen in the deployed position when the openable extension is opened.

6. A printer device comprising:
a chassis;
an output bin at least partially defining a paper path;
a display screen, along the paper path, rotatably attached to a rim of the chassis and rotatable between a stored position, at the rim, and a deployed position extending from the rim; and
a paper support located along the paper path between the display screen and the output bin, the display screen rotatably attached to the paper support the paper support movable between a folded position, at the rim, and an extended position to prevent paper from blocking the display screen or to prevent the paper from hitting a back of the display screen or to prevent the display screen from blocking the paper path, the paper support movable between the folded position and the extended position as the display screen rotates respectively between the stored position and the deployed position.

7. The printer device claim 6, wherein the paper support comprises a first portion and a second portion, the first portion rotatably attached to the rim, and the second portion extendable from the first portion, the display screen rotatably attached to the rim and the second portion such that, as the display screen rotates from the rim towards the deployed position, the display screen extends the second portion from the first portion as the first portion rotates relative to the rim.

8. The printer device claim 6, wherein the paper support is slidably attached to the rim, such that, as the display screen rotates from the rim towards the deployed position, the paper support is slidably pulled relative to the rim into the extended position.

9. The printer device claim 6, wherein the display screen is recessed at the rim in the stored position and the paper support is recessed at the rim in the folded position.

10. The printer device claim 6, further comprising a recess in the rim beside the display screen to provide manual access to an edge of the display screen to pull the display screen from the stored position towards the deployed position.

11. A printer device comprising:
a chassis;
an output bin at least partially defining a paper path;
a display screen rotatably attached to a rim of the chassis and movable between a stored position, at the rim, and a deployed position, extending from the rim; and
a paper support located along the paper path between the display screen and the output bin, the display screen slidably attached to the paper support such that the paper support is pulled by the display screen from a folded position, at the rim, to an extended position, as the display screen rotates respectively from the stored position to the deployed position.

12. The printer device claim 11, wherein the display screen is along the paper path and about aligned with the paper support, the display screen slidably attached to the paper support using one sliding mechanism or two sliding mechanisms.

13. The printer device claim 11, wherein the display screen is adjacent the paper support, out of the paper path, or partially out of the paper path, the display screen slidably attached to the paper support using one sliding mechanism.

14. The printer device claim 11, wherein the display screen is recessed at the rim in the stored position.

15. The printer device claim 11, wherein the paper support is recessed at the rim in the folded position.
